(19) United States
(12) Patent Application Publication
(10) Pub. No.: US 2021/0123003 A1
(43) Pub. Date: Apr. 29, 2021

(54) CHINESE YELLOW RICE WINE RICH IN ACTIVE INGREDIENTS OF STACHYS SIEBOLDII MIQ. AND ALLIUM CEPA L. AND BREWING PROCESS THEREOF

(71) Applicant: Shaanxi Univerisity of Technology, Hanzhong City (CN)

(72) Inventors: Jingzhang Geng, Hanzhong City (CN); Dongqin Li, Hanzhong City (CN); Xinsheng Li, Hanzhong City (CN); Jinjin Pei, Hanzhong City (CN); Hai Jiang, Hanzhong City (CN)

(21) Appl. No.: 17/026,500

(22) Filed: Sep. 21, 2020

(30) Foreign Application Priority Data
Oct. 28, 2019 (CN) 201911030125.8

(51) Int. Cl. C12G 3/026; C12G 3/022; C12H 1/07; C12H 1/18

(52) U.S. Cl. CPC C12G 3/026; C12H 1/18; C12H 1/063; C12G 3/022

(57) ABSTRACT

A brewing process of a Chinese yellow rice wine rich in active ingredients of Stachys sieboldii Miq. and Allium cepa L. by preparing Stachys sieboldii Miq. and Allium cepa L. into a juice or a powder respectively; immersing raw glutinous rice in water for water absorption and expansion, steaming, placing in a fermentation tank for pre-fermentation, stirring with a rake regularly when a temperature of fermented materials rises to a certain temperature to obtain a pre-fermented product; post-fermenting with the pre-fermented product, press filtering, allowing a press filtrate to stand still for clarification, filtering, heat sterilizing, adding a juice containing active ingredients of the Stachys sieboldii Miq. and a juice containing active ingredients of the Allium cepa L. into every 1 L of the press filtrate to obtain a Chinese yellow rice wine rich in active ingredients of Stachys sieboldii Miq. and Allium cepa L.

### TECHNICAL FIELD

The present invention belongs to the technical field of Chinese yellow rice wine production, and relates to a Chinese yellow rice wine rich in active ingredients of Stachys sieboldii Miq. and Allium cepa L. and a brewing process thereof.

### BACKGROUND

Chinese yellow rice wine is a Chinese special product known as one of the world's three major ancient wines, the other two being beer and wine. It is brewed with unique brewing technology and has become a typical model of the oriental brewing industry. It has more than 5,000 years of history and culture in China and enjoys a reputation of “national wine”. The Chinese yellow rice wine has features such as soft, smooth, full body, mellow taste, rich nutrition, low alcohol content and useful in a diet therapy and a medical treatment, and suits a new trend of consumer value of the current society.

Stachys sieboldii Miq. is a perennial herb of the genus Stachys in the Lamiaceae family, commonly known as grass silkworm, manna, screw vegetable, and ground tumor. Underground tubers thereof are white as jade, take a spiral tower shape, and are very delicious with the flesh tastes crispy and tender. Every 100 g of fresh Stachys sieboldii Miq. mainly includes the following nutritional components: about 20 g of carbohydrate, 2.2-5.5 g of protein, 0.3 g of lipid, and other minerals, vitamins and a lot of water, where stachyose, a functional oligosaccharide, is an active ingredient. The Stachys sieboldii Miq. mainly have effects such as nourishing yin, producing fluid, replenishing spleen and stomach, cleaning liver and gallbladder, strengthening tendons, lowering lipids and blood glucose and inhibiting tumors.

Allium cepa L. is a perennial plant of the Allium genus in Liliaceae family. It is originated in western Asia and is widely cultivated both in China and abroad. It is one of the main vegetables grown in China. The Allium cepa L. is rich in nutrients, for example, potassium, vitamin C, folic acid, zinc, selenium, niacin and fiber, and has two special nutrients: quercetin and prostaglandin A. It has effects such as beautifying, lowering blood pressure and blood lipids, anti-arteriosclerosis, inhibiting cancers such as gastric cancer, esophageal cancer, colon cancer and breast cancer, and preventing osteoporosis.

A search shows that, there is no drink of Chinese yellow rice wine containing the active ingredients of Stachys sieboldii Miq. and Allium cepa L. yet.

### SUMMARY

A technical problem solved by the present invention is to provide to a Chinese yellow rice wine rich in active ingredients of Stachys sieboldii Miq. and Allium cepa L. and a brewing process thereof. The present invention develops a new drink of Chinese yellow rice wine.

The present invention is implemented by the following technical solutions.

A brewing process of a Chinese yellow rice wine rich in active ingredients of Stachys sieboldii Miq. and Allium cepa L. includes the following steps:

step 1: selecting fresh Stachys sieboldii Miq. and Allium cepa L., preparing a juice containing active ingredients of the Stachys sieboldii Miq. and a juice containing active ingredients of the Allium cepa L.;

or, drying the Stachys sieboldii Miq. and the Allium cepa L. to a water content of 10-12% respectively and pulverizing to obtain a Stachys sieboldii Miq. powder and a Allium cepa L. powder;

step 2: immersing raw glutinous rice in clean water to allow water absorption and expansion, taking out the glutinous rice, steaming, cooling to 28-30° C., mixing with a wine yeast, placing in a fermentation tank for pre-fermentation at 28-30° C., stirring with a rake regularly when a temperature of fermented materials rises to 32-35° C. to obtain a pre-fermented product;

step 3: post-fermenting with the pre-fermented product at 10-20° C., press filtering, allowing a press filtrate to stand still at −5-0° C. for clarification, filtering, placing in ohmic heating equipment for sterilization, adding 30-50 mL of the juice containing active ingredients of the Stachys sieboldii Miq. and 30-50 mL of the juice containing active ingredients of the Allium cepa L. to every 1 L of sterilized press filtrate to obtain a Chinese yellow rice wine rich in active ingredients of Stachys sieboldii Miq. and Allium cepa L.;

or, adding the Stachys sieboldii Miq. powder and the Allium cepa L. powder to the pre-fermented product, where the mass of the Stachys sieboldii Miq. powder and the Allium cepa L. powder were 5-10% of the mass of the raw glutinous rice respectively, post-fermenting at 10-20° C., press filtering, allowing a press filtrate to stand still for clarification, filtering, placing in ohmic heating equipment and sterilizing to obtain a Chinese yellow rice wine rich in active ingredients of Stachys sieboldii Miq. and Allium cepa L.

Further, in step 1, the juice containing active ingredients of the Stachys sieboldii Miq. is prepared by washing the Stachys sieboldii Miq., removing impurities and pressing to obtain a juice; the juice containing active ingredients of the Allium cepa L. is prepared by washing the Allium cepa L., removing impurities, naturally drying to a water content of 70-90% and pressing to obtain a juice.

Further, in step 1, the juice containing active ingredients of the Stachys sieboldii Miq. is prepared by drying the Stachys sieboldii Miq. to a water content of 10-12%, pulverizing to 80-120 mesh, immersing in water in a mass ratio of 1:(2-3) for 1-2 h, and extracting by an extraction method to obtain an extracted solution containing active ingredients of the Stachys sieboldii Miq.; in step 1, the juice containing active ingredients of the Allium cepa L. is prepared by low-temperature drying the Allium cepa L. to a water content of 10-12%, pulverizing to 80-120 mesh, immersing in water in a mass ratio of 1:(2-3) for 1-2 h, and extracting by an extraction method to obtain an extracted solution containing active ingredients of the Allium cepa L.

Further, in step 2, the immersing is carried out at 10-20° C. for 5-7 d.

Further, in step 2, the pre-fermentation lasts for 7-10 d.

Further, in step 2, the stirring with a rake is carried out every 4-6 h with a total number of 15-30 times.

Further, in step 3, the post-fermenting lasts for 30-60 d.

Further, in step 3, the stand still is carried out by placing a press filtrate in a freezer and allowing to stand still at −5-0° C. for 12-24 h.

Further, in step 3, the sterilization is carried out at 80-85° C. for 5-10 min,

Further, the Chinese yellow rice wine rich in active ingredients of Stachys sieboldii Miq. and Allium cepa L. has an oligosaccharide content of not less than 500 mg/L, where stachyose is not less than 300 mg/L.

Compared with the prior art, the present invention has the following beneficial technical effects.

The present invention provides a Chinese yellow rice wine rich in active ingredients of Stachys sieboldii Miq. and Allium cepa L. and a brewing process thereof. The Chinese yellow rice wine rich in active ingredients of Stachys sieboldii Miq. and Allium cepa L. is prepared by adding active ingredients of Stachys sieboldii Miq. and Allium cepa L. in different forms at different stages of wine making to obtain a mixed liquor and a fermented liquor. The present invention develops a new Chinese yellow rice wine, and provides a new feasible way for deep processing and utilization of Stachys sieboldii Miq. and Allium cepa L. Utilization of functional factors in Stachys sieboldii Miq. and Allium cepa L. is improved through decomposition in microbial fermentation or through immersing and extracting. Raw materials of Stachys sieboldii Miq. and Allium cepa L. rich in oligosaccharides and other active ingredients are added into pre-fermented materials for co-fermentation to provide rich nutrients for microorganisms and promote fermentation. Thus, utilization of glutinous rice is improved, and beneficial components of Stachys sieboldii Miq. and Allium cepa L. are decomposed to a certain extent. A glutinous rice yellow rice wine as a base wine is directly added with beneficial components of Stachys sieboldii Miq. and Allium cepa L. to obtain a mixed liquor. The wine can activate blood and thus is helpful in accelerating absorption and utilization of relevant nutrients by the human body. The wine also has advantages in effects such as nourishing yin, producing fluid, replenishing spleen and stomach, cleaning liver and gallbladder, strengthening tendons, lowering lipids and blood glucose and inhibiting tumors. The present invention provides a feasible way for deep processing and utilization of Stachys sieboldii Miq. and Allium cepa L. Moreover, the produced Chinese yellow rice wine undergoes heat sterilization in ohmic heating equipment which uses low-frequency alternating current. When the current passes through the yellow rice wine which includes electrolytes such as organic acids and which has electrical conductivity and electrical impedance, the electrical energy is quickly converted into heat energy in the yellow rice wine, raising the temperature of the wine, so as to achieve rapid heating. Compared with traditional heat sterilization methods, ohmic heating has advantages such as fast and uniform heating, less mechanical damage to a product, high energy efficiency and low energy consumption.

### DETAILED DESCRIPTION

Specific examples are given below.

### EXAMPLE 1

A brewing process of a Chinese yellow rice wine rich in active ingredients of Stachys sieboldii Miq. and Allium cepa L. included the following steps:

Step 1: Fresh Stachys sieboldii Miq. and purple-skinned Allium cepa L. which were harvested in the current year and were free of pesticides and chemical fertilizers were selected. The Stachys sieboldii Miq. was washed with impurities removed and pressed to obtain a juice. Or the Stachys sieboldii Miq. was dried to a water content of 10%, pulverized to 80 mesh, immersed in water in a mass ratio of 1:2 for 2 h, and extracted by an extraction method to obtain an extracted solution containing active ingredients of the Stachys sieboldii Miq., so as to obtain a juice containing the active ingredients of the Stachys sieboldii Miq.

The Allium cepa L. was washed with impurities removed, dried naturally to a water content of 70%, and pressed to obtain a juice. Or the Allium cepa L. was dried at a low temperature to a water content of 10%, pulverized to 80 mesh, immersed in water in a mass ratio of 1:2 for 2 h, and extracted by an extraction method to obtain an extracted solution containing active ingredients of the Allium cepa L., so as to obtain a juice containing the active ingredients of the Allium cepa L.

Or, the Stachys sieboldii Miq. and the Allium cepa L. were dried at a low temperature to a water content of 10% and pulverized to 80 mesh respectively to obtain a Stachys sieboldii Miq. powder and a Allium cepa L. powder.

Step 2: After impurity removing, weighing and washing, raw glutinous rice was immersed in clean water at 20° C. for 5 d to allow water absorption and expansion. Then the rice was removed and steamed. The steamed glutinous rice was cooled to 28° C., mixed with a wine yeast and placed in a fermentation tank for pre-fermentation at 28° C. for 7 d. When the temperature of fermented materials rose to 35° C., stirring was carried out with a rake and repeated every 4 h for a total number of 15 times to obtain a pre-fermented product.

Step 3: The pre-fermented product was post-fermented at 10° C. for 60 d, and press filtered conventionally. A press filtrate was placed in a freezer and allowed to stand still at −5° C. for 12 h for clarification and then filtered. The filtered press filtrate was placed in ohmic heating equipment and sterilized at 85° C. for 10 min, 50 mL of the juice containing the active ingredients of the Stachys sieboldii Miq. and 50 mL of the juice containing the active ingredients of the Allium cepa L. were added to every 1 L of sterilized press filtrate to obtain a Chinese yellow rice wine rich in active ingredients of Stachys sieboldii Miq. and Allium cepa L.

Or, the pre-fermented product was added with the Stachys sieboldii Miq. powder and the Allium cepa L. powder where the mass of the Stachys sieboldii Miq. powder and the Allium cepa L. powder were 7% of the mass of the raw glutinous rice respectively. Post-fermentation was carried out at 10° C. for 60 d, and press filtration was carried out conventionally. A press filtrate was placed in a freezer and allowed to stand still at −5° C. for 12 h for clarification and then filtered. The filtered press filtrate was placed in ohmic heating equipment and sterilized at 85° C. for 10 min to obtain a Chinese yellow rice wine rich in active ingredients of Stachys sieboldii Miq. and Allium cepa L.

The obtained Chinese yellow rice wine product had an oligosaccharide content of 530 mg/L, where stachyose was 310 mg/L.

### EXAMPLE 2

A brewing process of a Chinese yellow rice wine rich in active ingredients of Stachys sieboldii Miq. and Allium cepa L. included the following steps:

Step 1: Fresh Stachys sieboldii Miq. and purple-skinned Allium cepa L. which were harvested in the current year and were free of pesticides and chemical fertilizers were selected. The Stachys sieboldii Miq. was washed with impurities removed and pressed to obtain a juice. Or the Stachys sieboldii Miq. was dried to a water content of 12%, pulverized to 120 mesh, immersed in water in a mass ratio of 1:3 for 2 h, and extracted by an extraction method to obtain an extracted solution containing active ingredients of the Stachys sieboldii Miq., so as to obtain a juice containing the active ingredients of the Stachys sieboldii Miq.

The Allium cepa L. was washed with impurities removed, dried naturally to a water content of 90%, and, pressed to obtain a juice. Or the Allium cepa L. was dried at a low temperature to a water content of 12%, pulverized to 120 mesh, immersed in water in a mass ratio of 1:3 for 2 h, and extracted by an extraction method to obtain an extracted solution containing active ingredients of the Allium cepa L., so as to obtain a juice containing the active ingredients of the Allium cepa L.

Or, the Stachys sieboldii Miq. and the Allium cepa L. were dried at a low temperature to a water content of 12% and pulverized to 120 mesh respectively to obtain a Stachys sieboldii Miq. powder and a Allium cepa L. powder.

Step 2: After impurity removing, weighing and washing, raw glutinous rice was immersed in clean water at 20° C. for 7 d to allow water absorption and expansion. Then the rice was removed and steamed. The steamed glutinous rice was cooled to 30° C., mixed with a wine yeast and placed in a fermentation tank for pre-fermentation at 30° C. for 7 d. When the temperature of fermented materials rose to 35° C., stirring was carried out with a rake and repeated every 4 h for a total number of 15 times to obtain a pre-fermented product.

Step 3: The pre-fermented product was post-fermented at 20° C. for 30 d, and press filtered conventionally. A press filtrate was placed in a freezer and allowed to stand still at 0° C. for 24 h for clarification and then filtered. The filtered press filtrate was placed in ohmic heating equipment and sterilized at 80° C. for 5 min. 30 mL of the juice containing the active ingredients of the Stachys sieboldii Miq. and 30 mL of the juice containing the active ingredients of the Allium cepa L. were added to every 1 L of sterilized press filtrate to obtain a Chinese yellow rice wine rich in active ingredients of Stachys sieboldii Miq. and Allium cepa L.

Or, the pre-fermented product was added with the Stachys sieboldii Miq. powder and the Allium cepa L. powder where the mass of the Stachys sieboldii Miq. powder and the Allium cepa L. powder were 10% of the mass of the raw glutinous rice respectively. Post-fermentation was carried out at 20° C. for 30 d, and press filtration was carried out conventionally. A press filtrate was placed in a freezer and allowed to stand still at 0° C. for 24 h for clarification and then filtered. The filtered press filtrate was placed in ohmic heating equipment and sterilized at 80° C. for 5 min to obtain a Chinese yellow rice wine rich in active ingredients of Stachys sieboldii Miq. and Allium cepa L.

The obtained Chinese yellow rice wine product had an oligosaccharide content of 510 mg/L, where stachyose was 315 mg/L.

Experiment of Lowering Blood Glucose

An insulin-induced hyperglycemia animal model was used. The experiment included an experimental group 1, an experimental group 2, a model group and a blank group with 15 mice a group. The experimental group 1, the experimental group 2 and the model group were injected with alloxan to establish a hyperglycemia model with a blood glucose value of 10-25 mmol/L. The blank control group was not treated. Test samples were administered for 30 d. The experimental group 1 and the experimental group 2 were fed with the Chinese yellow rice wine rich in active ingredients of Stachys sieboldii Miq. and Allium cepa L. produced in Example 1 and Example 2 which were diluted to 3.0 g/kg respectively. Fasting blood glucose values were measured and compared between the experimental group 1 or the experimental group 2 and the model group respectively, and percentages of decrease were calculated. Results showed that, the fasting blood glucose of the experimental group 1 was decreased by 12.7%; the fasting blood glucose of the experimental group 2 was decreased by 14.5%; the fasting blood glucose of the blank group was decreased by −0.21%; and the fasting blood glucose of the model group was decreased by −0.22%. The results indicated that there was no significant difference for the model group and the blank group before and after the experiment (P≥0.05), and thus the experiment was determined to be valid. There was a significant difference in blood glucose value for the experimental group 1 and the experimental group 2 before and after the experiment (P≤0.05). It was determined that the two example groups can lower the blood glucose of experimental animals, and the Stachys sieboldii Miq. and the Allium cepa L. had an effect of lowering blood glucose.

Experiment of Lowering Blood Lipids

An insulin resistant and glucose/lipid metabolism disorder model was used as an experimental model. The experiment included an experimental group 1, an experimental group 2, a model group and a blank group with 15 mice a group. The experimental group 1 and the experimental group 2 were fed with the Chinese yellow rice wine rich in active ingredients of Stachys sieboldii Miq. and Allium cepa L. produced in Example 1 and Example 2 which were diluted to 3.0 g/kg respectively. The blank control group was not treated. The model group was fed with a solvent in a same volume. Animals were fasted for 3-4 h before detection of total cholesterol (TC) and triglyceride (TG) levels in the serum, The TC and TG levels in the serum of the animals were compared between dose groups and the model control group respectively and percentages of decrease were calculated. Results showed that, for the experimental group 1, the TC was decreased by 13.5% and the TG was decreased by 18.6%. For the experimental group 2, the TC was decreased by 14.6% and the TG was decreased by 19.7%. For the blank group, the TC was decreased by 2.2% and the TG was decreased by 1.3%. For the model group, the TC was decreased by 3.1% and the TG was decreased by 1.3%. Results showed that, there was a significant difference in blood lipid value for the experimental group 1 and the experimental group 2 compared with the model group or the blank group after the experiment. It was determined that the two example groups can lower the blood lipids of experimental animals, and the Chinese yellow rice wine rich in active ingredients of Stachys sieboldii Miq. and Allium cepa L. had an effect of lowering blood lipids.

Experiment of Relieving Exercise Fatigue of Mice

100 mice were divided into the following 5 groups randomly with 20 mice a group: experimental group 1, experimental group 2, experimental group 3, experimental group 4 and blank group. The experimental group 1, the experimental group 2, the experimental group 3 and the experimental group 4 were administered with 2.5 g/kg Chinese yellow rice wine rich in active ingredients of Stachys sieboldii Miq. and Allium cepa L. The blank group was administered with 2.5 g/kg normal saline. Administration was carried out by gavage once a day for 20 consecutive days. 1 h after the last administration, a 5% lead mass was attached to the base of the tail of each mouse which was then placed in a thermostatic water bath with a water depth of 25 cm at 25±0.5 ° C. The time was recorded for the mice from entering water to sinking into water for 9 s without coming out again after exhaustion as the weight-bearing exercise time of the mice. After detection, the average weight-bearing swimming time of mice in the blank group was 5.12±0.34 min, and it was 7.16±0.23 min for the experimental group 1, 8.01±0.15 min for the experimental group 2, 8.05±0.27 min for the experimental group 3 and 8.17±0.30 min for the experimental group 4. The results showed that the Chinese yellow rice wine rich in active ingredients of Stachys sieboldii Miq. and Allium cepa L. of the present invention can effectively relieve exercise fatigue of mice, and significantly extend the average weight-bearing swimming time of mice.

Experiment of Relieving Dyspepsia

100 patients of 25-40 years old with dyspepsia were selected. The symptoms included upper abdominal pain, bloating, heartburn, heating, chest tightness, stomach fullness, and abdominal distension. The patients were divided into experimental group 1, experimental group 2, experimental group 3 and experimental group 4. The experimental group 1 and the experimental group 2 were administered with the Chinese yellow rice wine produced in Example 1 of the present invention, and the experimental group 3 and the experimental group 4 were administered with the Chinese yellow rice wine produced in Example 2 of the present invention. The administration was carried out once a day, 50 mL each time. The therapeutic effect was observed, including cured, that is, disappear of all symptoms such as upper abdominal pain, bloating, heartburn, heating, chest tightness, stomach fullness and abdominal distension; effective, that is, disappear of the upper abdominal pain and significant improvement of other symptoms; and invalid, that is, the clinical symptoms remained unchanged. After administration of the Chinese yellow rice wine for 100 d, the experimental group 1 had an effective rate of 60% and a cure rate of 51%. The experimental group 2 had an effective rate of 80% and a cure rate of 70%. The experimental group 3 had an effective rate of 82% and a cure rate of 73%. The experimental group 4 had an effective rate of 85% and a cure rate of 76%.

### EXAMPLE 3

A brewing process of a Chinese yellow rice wine rich in active ingredients of Stachys sieboldii Miq. and Allium cepa L. included the following steps:

Step 1: Fresh Stachys sieboldii Miq. and. purple-skinned Allium cepa L. which were harvested in the current year and were free of pesticides and chemical fertilizers were selected. The Stachys sieboldii Miq. was washed with impurities removed and pressed to obtain a juice. Or the Stachys sieboldii Miq. was dried to a water content of 11%, pulverized to 100 mesh, immersed in water in a mass ratio of 1:2 for 1 h, and extracted by an extraction method to obtain an extracted solution containing active ingredients of Stachys sieboldii Miq., so as to obtain a juice containing the active ingredients of the Stachys sieboldii Miq.

The Allium cepa L. was washed with impurities removed, dried naturally to a water content of 75%, and pressed to obtain a juice. Or the Allium cepa L. was dried at a low temperature to a water content of 11%, pulverized to 100 mesh, immersed in water in a mass ratio of 1:2 for 1 h, and extracted by an extraction method to obtain an extracted solution containing active ingredients of Allium cepa L., so as to obtain a juice containing the active ingredients of the Allium cepa L.

Or, the Stachys sieboldii Miq. and the Allium cepa L. were dried at a low temperature to a water content of 11% and pulverized to 100 mesh respectively to obtain a Stachys sieboldii Miq. powder and a Allium cepa L. powder.

Step 2: After impurity removing, weighing and washing, raw glutinous rice was immersed in clean water at 10° C. for 6 d to allow water absorption and expansion. Then the rice was removed and steamed. The steamed glutinous rice was cooled to 29° C., mixed with a wine yeast and placed in a fermentation tank for pre-fermentation at 29° C. for 10 d. When the temperature of fermented materials rose to 32° C., stirring was carried out with a rake and repeated every 6 h for a total number of 30 times to obtain a pre-fermented product.

Step 3: The pre-fermented product was post-fermented at 18° C. for 35 d, and press filtered conventionally. A press filtrate was placed in a freezer and allowed to stand still at −3° C. for 16 h for clarification and then filtered. The filtered press filtrate was placed in ohmic heating equipment and sterilized at 82° C. for 7 min. 40 ml, of the juice containing the active ingredients of the Stachys sieboldii Miq. and 40 mL of the juice containing the active ingredients of the Allium cepa L. were added to every 1 L of sterilized press filtrate to obtain a Chinese yellow rice wine rich in active ingredients of Stachys sieboldii Miq. and Allium cepa L.

Or, the pre-fermented product was added with the Stachys sieboldii Miq. powder and the Allium cepa L. powder where the mass of the Stachys sieboldii Miq. powder and the Allium cepa L. powder were 5% of the mass of the raw glutinous rice respectively. Post-fermentation was carried out at 18° C. for 35 d, and press filtration was carried out conventionally. A press filtrate was placed in a freezer and allowed to stand still at −3° C. for 16 h for clarification and then filtered. The filtered press filtrate was placed in ohmic heating equipment and sterilized at 82° C. for 7 min to obtain a Chinese yellow rice wine rich in active ingredients of Stachys sieboldii Miq. and Allium cepa L.

The obtained Chinese yellow rice wine product had an oligosaccharide content of 540 mg/L, where stachyose was 320 mg/L.

### EXAMPLE 4

A brewing process of a Chinese yellow rice wine rich in active ingredients of Stachys sieboldii Miq. and Allium cepa L. included the following steps:

Step 1: Fresh Stachys sieboldii Miq. and purple-skinned Allium cepa L. which were harvested in the current year and were free of pesticides and chemical fertilizers were selected. The Stachys sieboldii Miq. was washed with impurities removed and pressed to obtain a juice. Or the Stachys sieboldii Miq. was dried to a water content of 10%, pulverized to 110 mesh, immersed in water in a mass ratio of 1:2.5 for 1.5 h. and extracted by an extraction method to obtain an extracted solution containing active ingredients of Stachys sieboldii Miq., so as to obtain a juice containing the active ingredients of the Stachys sieboldii Miq.

The Allium cepa L. was washed impurities removed, dried naturally to a water content of 85%, and pressed to obtain a juice. Or the Allium cepa L. was dried at a low temperature to a water content of 10%, pulverized to 110 mesh, immersed in wader mass ratio of 1:2.5 for 1.5 h, and extracted by an extraction method to obtain an extracted solution containing active ingredients of Allium cepa L., so a.s to obtain a juice containing the active ingredients of the Allium cepa L.

Or, the Stachys sieboldii Miq. and the Allium cepa L. were dried at a low temperature to a water content of 10% and pulverized to 110 mesh respectively to obtain a Stachys sieboldii Miq. powder and a Allium cepa L. powder.

Step 2: After impurity removing, weighing and washing, raw glutinous rice was immersed in clean water at 15° C. for 7 d to allow water absorption and expansion. Then the rice was removed and steamed. The steamed glutinous rice was cooled to 30° C., mixed with a wine yeast and placed in a fermentation tank for pre-fermentation at 30° C. for 7 d. When the temperature of fermented materials rose to 34° C., stirring was carried out with a rake and repeated every 5 h for a total number of 20 times to obtain a pre-fermented product.

Step 3: The pre-fermented product was post-fermented at 12° C. for 48 d, and press filtered conventionally. A press filtrate was placed in a freezer and allowed to stand still at −2° C. for 20 h for clarification and then filtered. The filtered press filtrate was placed in ohmic heating equipment and sterilized at 83° C. for 8 min. 45 mL of the juice containing the active ingredients of the Stachys sieboldii Miq. and 45 mL of the juice containing the active ingredients of the Allium cepa L. were added to every 1 L of sterilized press filtrate to obtain a Chinese yellow rice wine rich in active ingredients of Stachys sieboldii Miq. and Allium cepa L.

Or, the pre-fermented product was added with the Stachys sieboldii Miq. powder and the Allium cepa L. powder where the mass of the Stachys sieboldii Miq. powder and the Allium cepa L. powder were 9% of the mass of the raw glutinous rice respectively. Post-fermentation was carried out at 12° C. for 48 d, and press filtration was carried out conventionally. A press filtrate was placed in a freezer and allowed to stand still at −2° C. for 20 h for clarification and then filtered. The filtered press filtrate was placed in ohmic heating equipment and sterilized at 83° C. for 8 min to obtain a Chinese yellow rice wine rich in active ingredients of Stachys sieboldii Miq. and Allium cepa L.

The obtained Chinese yellow rice wine product ad an oligosaccharide content of 525 mg/L, where stachyose was 320 mg/L.

The sensory indicators of the produced Chinese yellow rice wine: the color was clear and transparent, the smell was yellow rice wine-specific aromatic and the mouthfeel was mellow and refreshing, with no peculiar taste.

Physical and chemical indicators of the products of the Chinese yellow rice wine rich in active ingredients of Stachys sieboldii Miq. and Allium cepa L.

| Item | Index |
|---|---|
| Oligosaccharides/(mg/L) | ≥500 |
| Stachyose/(mg/L) | ≥300 |
| Non-sugar solids/(g/L) | ≥7.0 |
| Alcohol content (20° C.)/(% vol) | ≥8 |
| pH | 3.5-4.6 |
| Total acid (in Lactic acid)/(g/L) | 1.0-5.5 |
| Amino acid nitrogen/(g/L) | ≥0.3 |
| Lead (in Pb)/(mg/L) | ≤0.5 |
| Calcium oxide/(g/L) | ≤0.5 |

What is claimed is:

1. A brewing process of a Chinese yellow rice wine rich in active ingredients of Stachys sieboldii Miq. and Allium cepa L., comprising the following steps:
step 1: selecting fresh Stachys sieboldii Miq. and Allium cepa L., preparing a juice containing active ingredients of the Stachys sieboldii Miq. and a juice containing active ingredients of the Allium cepa L.;
or, drying the Stachys sieboldii Miq. and the Allium cepa L. to a water content of 10-12% respectively and pulverizing to obtain a Stachys sieboldii Miq. powder and a Allium cepa L. powder;
step 2: immersing raw glutinous rice in clean water to allow water absorption and expansion, taking out the glutinous rice, steaming, cooling to 28-30° C., mixing with a wine yeast, placing in a fermentation tank for pre-fermentation at 28-30° C., stirring with a rake regularly when a temperature of fermented materials rises to 32-35° C. to obtain a pre-fermented product;
step 3: post-fermenting with the pre-fermented product at 10-20° C., press filtering, allowing a press filtrate to stand still at −5-0° C. for clarification, filtering, placing in ohmic heating equipment for sterilization, adding 30-50 mL of the juice containing active ingredients of the Stachys sieboldii Miq. and 30-50 mL of the juice containing active ingredients of the Allium cepa L. to every 1 L of sterilized press filtrate to obtain a Chinese yellow rice wine rich in active ingredients of Stachys sieboldii Miq. and Allium cepa L.;
or, adding the Stachys sieboldii Miq. powder and the Allium cepa L. powder to the pre-fermented product, wherein the mass of the Stachys sieboldii Miq. powder and the Allium cepa L. powder were 5-10% of the mass of the raw glutinous rice respectively, post-fermenting at 10-20° C., press filtering, allowing a press filtrate to stand still for clarification, filtering, placing in ohmic heating equipment and sterilizing to obtain a Chinese yellow rice wine rich in active ingredients of Stachys sieboldii Miq. and Allium cepa L.

2. The brewing process of a Chinese yellow rice wine rich in active ingredients of Stachys sieboldii Miq. and Allium cepa L. according to claim 1, wherein in step 1, the juice containing active ingredients of the Stachys sieboldii Miq. is prepared by washing the Stachys sieboldii Miq. removing impurities and pressing to obtain a juice; the juice containing active ingredients of the Allium cepa L. is prepared by washing the Allium cepa L., removing impurities, naturally drying to a water content of 70-90% and pressing to obtain a juice.

3. The brewing process of a Chinese yellow rice wine rich in active ingredients of Stachys sieboldii Miq. and Allium cepa L. according to claim 1, wherein in step 1, the juice containing active ingredients of the Stachys sieboldii Miq. is prepared by drying the Stachys sieboldii Miq. to a water content of 10-12%, pulverizing to 80-120 mesh, immersing in water in a mass ratio of 1:(2-3) for 1-2 h, and extracting by an extraction method to obtain an extracted solution containing active ingredients of the Stachys sieboldii Miq.; in step 1, the juice containing active ingredients of the Allium cepa L. is prepared by drying the Allium cepa L. to a water content of 10-12%, pulverizing to 80-120 mesh, immersing in water in a mass ratio of 1:(2-3) for 1-2 h, and extracting by an extraction method to obtain an extracted solution containing active ingredients of the Allium cepa L.

4. The brewing process of a Chinese yellow rice wine rich in active ingredients of Stachys sieboldii Miq. and Allium cepa L. according to claim 1, wherein in step 2, the immersing is carried out at 10-20° C. for 5-7 d.

5. The brewing process of a Chinese yellow rice wine rich in active ingredients of Stachys sieboldii Miq. and Allium cepa L. according to claim 1, wherein in step 2, the pre-fermentation lasts for 7-10 d.

6. The brewing process of a Chinese yellow rice wine rich in active ingredients of Stachys sieboldii Miq. and Allium cepa L. according to claim 1, wherein in step 2, the stirring with a rake is carried out every 4-6 h with a total number of 15-30 times.

7. The brewing process of a Chinese yellow rice wine rich in active ingredients of Stachys sieboldii Miq. and Allium cepa L. according to claim 1, wherein in step 3, the post-fermenting lasts for 30-60 d.

8. The brewing process of a Chinese yellow rice wine rich in active ingredients of Stachys sieboldii Miq. and Allium cepa L. according to claim 1, wherein in step 3. the stand still is carried out by placing a press filtrate in a freezer and allowing to stand still at −5-0° C. for 12-24 h.

9. The brewing process of a Chinese yellow rice wine rich in active ingredients of Stachys sieboldii Miq. and Allium cepa L. according to claim 1, wherein in step 3, the sterilization in ohmic heating equipment after filtration is carried out at 80-85° C. for 5-10 min.

10. The brewing process of a Chinese yellow rice wine rich in active ingredients of Stachys sieboldii Miq. and Allium cepa L. according to claim 1, wherein the Chinese yellow rice wine rich in active ingredients of Stachys sieboldii Miq. and Allium cepa L. has an oligosaccharide content of not less than 500 mg/L, wherein stachyose is not less than 300 mg/L.
